(19) United States
(12) Patent Application Publication
(10) Pub. No.: US 2017/0212992 A1
(43) Pub. Date: Jul. 27, 2017

(54) SYSTEMS AND METHODS FOR GENERATING HIGH RESOLUTION PROBABILISTIC RASTER MAPS FOR ELECTRONIC HEALTH RECORD AND OTHER DATA ASSOCIATED WITH A GEOGRAPHICAL REGION

(71) Applicant: Northwestern University, Evanston, IL (US)

(72) Inventors: Adam R. Pah, Chicago, IL (US); Jess J. Behrens, Chicago, IL (US); Satyender Goel, Chicago, IL (US); Abel N. Kho, Chicago, IL (US)

(21) Appl. No.: 15/416,042

(22) Filed: Jan. 26, 2017

Related U.S. Application Data
(60) Provisional application No. 62/287,164, filed on Jan. 26, 2016.

(51) Int. Cl. G06F 19/00; G06Q 30/02

(52) U.S. Cl. CPC G06F 19/322; G06Q 30/0205

(57) ABSTRACT

Described here are systems and methods for generating probabilistic maps that depict the probability distribution of data across a geographical region. More particularly, the systems and methods described here are capable of generating probabilistic maps of associated data at finer geographical resolution than is available for the associated data and are also capable of estimating and outputting related errors at that same geographical resolution.

### CROSS-REFERENCE TO RELATED APPLICATIONS

This application claims the benefit of U.S. Provisional Patent Application Ser. No. 62/287,164, filed on Jan. 26, 2016, and entitled “SYSTEMS AND METHODS FOR GENERATING HIGH RESOLUTION PROBABILISTIC RASTER MAPS FOR ELECTRONIC HEALTH RECORD AND OTHER DATA ASSOCIATED WITH A GEOGRAPHICAL REGION.”

### BACKGROUND

The field of the present disclosure is systems and methods for processing geographical and geospatial information. More particularly, the present disclosure relates to systems and methods for generating a raster map that depicts probabilistic information about data, such as electronic health record data, associated with a geographical region, where the raster map has a finer geographical resolution than the inputted data.

Electronic Health Record (“EHR”) systems provide a wealth of information that can be used to assess public health outcomes, especially in relation to the effect of environmental factors on disease prevalence. Frequently, these health records are aggregated at the zip code level, or larger, in order to protect patient privacy when performing data analyses. However, there are many instances where more variation exists within a zip code than between zip codes. In these instances, quantitative analyses can be hampered, and inadequate statistical associations between disease and environmental factors can be caused, especially when the overall frequency of a disease is low among the population.

Thus, there remains a need to provide systems and methods for analyzing information, such as information obtainable from EHR systems, with a finer geographical resolution than currently available, such as at a resolution scale that is finer than the postal code, or zip code, level.

### SUMMARY OF THE DISCLOSURE

The present disclosure addresses the aforementioned drawbacks by providing a computer-implemented method for generating a raster map that depicts probabilistic information related to data associated with locations within a geographical region. As one example, the associated data can include electronic health record (“EHR”) data or other clinical data associated with people residing within the geographical region. The method includes providing to a computer system, associated data that comprises information associated with first locations associated with at least one geographical region at a first geographical resolution. Geographical data that defines second locations associated with the at least one geographical region at a second geographical resolution that is finer than the first geographical resolution are also provided to the computer system. The associated data are then distributed across the second locations by the computer system. The associated data are thus distributed at the second geographical resolution. Averaged data are then generated at each of the second locations by averaging, with the computer system, the associated data distributed to each of the second locations. Subdivided data are then generated by subdividing, with the computer system, the averaged data at the second locations onto third locations associated with the at least one geographical region. These third locations define a third geographical resolution that is finer than the second geographical resolution. Kriged data are then produced with the computer system by processing the subdivided data at the third locations using a kriging process. A raster map is then generated from the kriged data by performing, with the computer system, a Gaussian geostatistical simulation on the kriged data. The raster map has pixels that depict a probability of the associated data being spatially correlated with the third locations.

The foregoing and other aspects and advantages of the present disclosure will appear from the following description. In the description, reference is made to the accompanying drawings that form a part hereof, and in which there is shown by way of illustration a preferred embodiment. This embodiment does not necessarily represent the full scope of the invention, however, and reference is therefore made to the claims and herein for interpreting the scope of the invention.

### BRIEF DESCRIPTION OF THE DRAWINGS

FIG. 1 is a flowchart setting forth the steps of an example method for generating a raster surface, or raster map, that depicts probabilistic and/or statistical information of associated data in a geographical region at a finer geographical resolution than is available for the associated data.

FIG. 2 depicts an example geographical region subdivided into locations at three different geographical resolutions.

FIG. 3 is a block diagram of an example computer system that can implement the methods described here.

FIGS. 4A and 4B depict demographic data for a patient population whose patient data was used in a case study implementing the methods described here.

FIG. 5 depicts electronic health record (“EHR”) information associated with diabetes incidence at a zip code level.

FIG. 6 depicts the EHR data from FIG. 4 distributed over census block groups using a Monte Carlo simulation procedure.

FIG. 7 depicts a raster surface that was generated by kriging and performing a Gaussian geostatistical simulation on the distributed EHR data of FIG. 5.

FIG. 8 depicts raster surfaces generated for estimating the probability of Medicaid patient locations in Albuquerque, N. Mex., and Chicago, Ill., which were generated by kriging and performing a Gaussian geostatistical simulation.

FIG. 9 depicts study areas based on North Carolina voter registration data, which were used as the basis of an example study using the methods of the present disclosure.

FIG. 10 depicts the error product by sample percent and the Gaussian extent and resolution in an example study using the methods of the present disclosure.

FIG. 11 depicts the RMSE error product by sample percent and the Gaussian extent and resolution in an example study using the methods of the present disclosure.

FIG. 12 depicts a comparison between various interpolation methods that can be implemented by the methods of the present disclosure.

### DETAILED DESCRIPTION

Described here are systems and methods for generating probabilistic maps that depict the probability distribution of data across a geographical region. More particularly, the systems and methods described here are capable of generating probabilistic maps of associated data at finer geographical resolution than is available for the associated data or other input geographical data.

Associated data can generally include any suitable information to be distributed and associated with a geographical region. As one example, associated data can include health record data for patients living in a certain geographical region. This associated data may also include demographic data for those patients. Associated data can also include demographic data, which may include gender, age, ethnicity and other socioeconomic data; housing data; consumer data; and so on for people living in a certain geographical region. Associated data may also include data not associated with human populations, but instead could include ecological data, geological data, geophysical data, and so on, which may be associated with a certain geographical region.

Geographical data can generally include data that defines or depicts geographical regions. In some instances, geographical data can also include associated data attributable to those geographic regions. One example of geographical data is census data, which not only defines geographical regions (e.g., census tracts, census block groups, census blocks), but some demographic data associated with those geographical regions. As other example, geographical data can include data defining human geographical regions (e.g., political and other human-made borders) and physical geographical regions.

In general, the systems and methods described here combine both geographical and statistical estimation procedures to achieve a more accurate prediction than previous models. As one example, patient electronic health record (“EHR”) data can be distributed across sub-regions in a geographical region with a finer geographical resolution than is available for either census data or the EHR data. Importantly, the systems and methods described here are also capable of providing and outputting the error estimates associated with the probabilistic map.

In many embodiments, the probabilistic map includes a raster surface, or raster map, that can have pixels, or raster cells, that depict probabilistic information, statistical information, or both, of the associated data at the finer geographical resolution. In one embodiment, the finer geographical resolution can correspond to census block-level or address-level resolution, whereas the associated data may only be available at census tract-level or census block group-level resolution.

To compensate for the poor geographical resolution of the associated data, a Monte Carlo simulation can be used to assign associated data to smaller geographical regions. For instance, the associated data may only be available at the zip code-level, but the Monte Carlo simulation can be performed to distribute the associated data at smaller localities, such as census block groups.

Assessing geographical disease burden is an essential part of both resource planning and understanding how care providers are serving their community. However, with the restrictions needed to protect patient privacy, the data needed to understand disease burden in small geographic areas is typically either unavailable or the results cannot be shared with outside entities. The systems and methods described in the present disclosure implement numerical and geographic simulations to create a probability surface of where patient cases reside at a much finer geographic resolution than available for the inputted patient data.

To address the limited geographical resolution of EHR, as one specific example, a probabilistic method is used to estimate the number of associated data that can be attributed to a finer geographic resolution, and that does not rely on any outside a priori assumptions. As one example, the methods can implement a Monte Carlo simulation that distributes patient cases given their demographic features and the known representation of these features in an area from census data, and then implements a geographical simulation that corrects for spatial aggregation error and uncertainty within the data. The methods thus produce a map of estimated case numbers, with an appropriate continuous calculated error, for the given dataset over the specified geography.

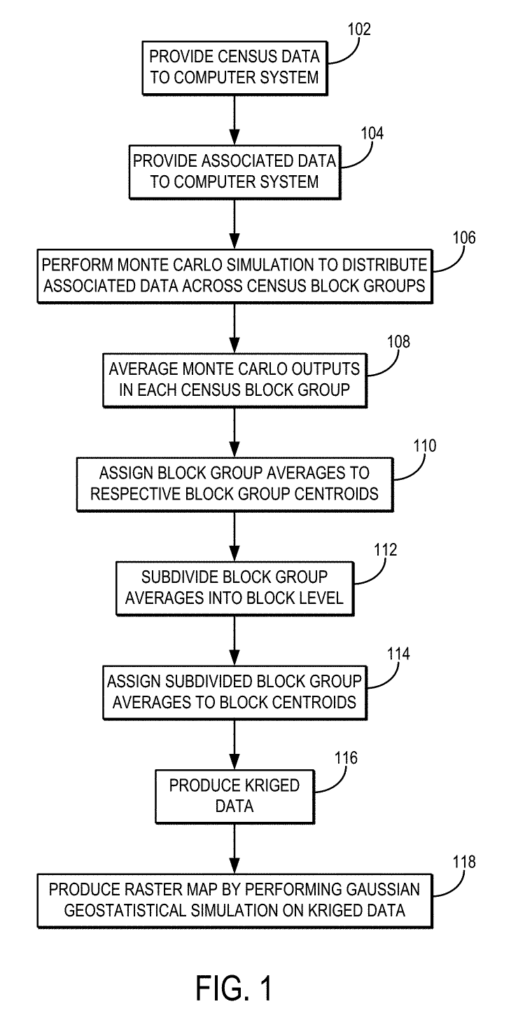

Referring now to FIG. 1, a flowchart is illustrated as setting forth the steps of an example method for generating a raster map that depicts probabilistic information, statistical information, or both, of associated data over a geographical region with finer geographical resolution than the inputted associated data. In general, the input data can include census data, or other geographical data, and associated data. As one specific example, the associated data can include patient data, such as patient EHR data.

The method thus includes providing census, or other geographical, data to a computer system, as indicated at step 102, and providing associated data to the computer system, as indicated at step 104. Census data can include, gender, age, and ethnicity information associated with geographical regions, such as census tracts, census block groups, census blocks, or combinations thereof. The associated data preferably includes data to be distributed in the geographical region, and can include demographic data similar to that in the census data. For example, the associated data can include patient EHR data in addition to demographic data, such as gender, age, and ethnicity, for different people residing in the associated geographical region. The associated data includes information that is available at a first geographical resolution within the geographical region. For example, the associated data can include information available at the postal code, or zip code, level.

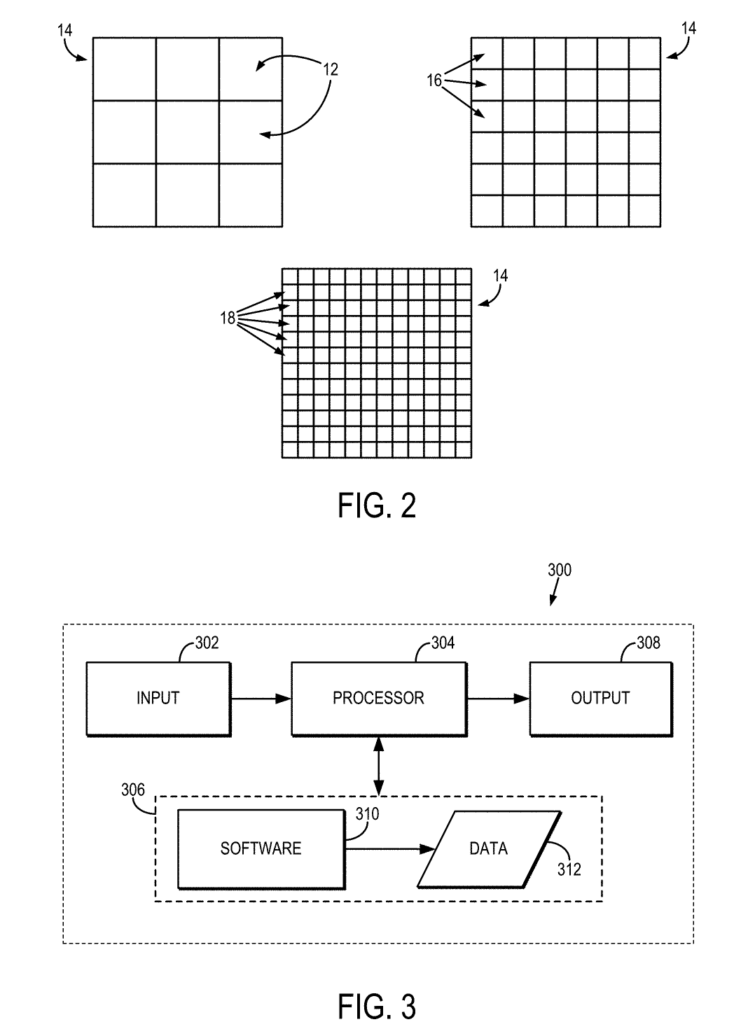

Referring briefly to FIG. 2, a general process for refining the geographical resolution of the associated data is illustrated. As will be described in detail below, the associated data is available at first locations 12 in a geographical region 14. The first locations thus define a first geographical resolution. The geographical data, however, defines second locations 16 in the geographical region 14, which are thus associated with a second geographical resolution that is finer than the first geographical resolution. Through the method described below, the associated data can be distributed across the second locations at the second geographical resolution, and can then be subdivided onto third locations 18 in the geographical region 14. As can be seen in FIG. 2, these third locations 18 are associated with a third geographical resolution that is finer than the second geographical resolution.

As mentioned above, EHR data is generally available with geographical resolution no finer than the postal code level. Thus, even if census data is available at finer geographical resolutions (e.g., census block group or block group levels) the EHR data cannot be readily distributed across that finer geographical resolution.

Referring again to FIG. 1, a Monte Carlo simulation is performed to distribute the associated data across the geographic region represented in the census data, as indicated at step 106. For instance, the associated data are distributed across locations associated with the geographical region that define a second geographical resolution that is finer than the geographical resolution at which the associated data are originally available. As one example, the second geographical resolution can correspond to census block groups.

Preferably, the Monte Carlo simulation randomly distributes the associated data in the geographical region, and does so at a first geographical resolution, such as a census block group. As a specific example, a Monte Carlo simulation can be performed to randomly distribute patient cases within a zip code, or postal code. In each simulation a patient with age, a, race, r, and gender, g, is probabilistically assigned to a census block group. The probability for each block group is calculated as,

$$p = \frac{{P}_{i}^{a , r , g}}{{\sum }_{n} {P}_{j}^{a , r , g}} ; \qquad ( 1 )$$

where P^{a,r,g} is the block group population for a given age, race, and gender segment, and n is the total number of block groups in the patient zip code. If a patient is missing any demographic field then the population used is based on the remaining, known demographic attributes (e.g., a patient missing the gender field would have block group populations tabulated as P^{a,r}). Each patient case is assigned to a block group and the number of cases in each block group is summed in the output. This process is repeated to produce many (e.g., thousands of) independent realizations of the distribution of patient cases.

The number of patient cases in each block group is averaged from the realizations outputted by the Monte Carlo simulation, as indicated at step 108, thereby producing averaged data at locations in the geographical region at which the associated data were distributed. Thus, the averaged data is also associated with the second geographical resolution, which is finer than the first geographical resolution. Each block group average is then assigned to the geographic centroid for the block group, as indicated at step 110. For instance, the block group averages can be imported into a geographic information system (“GIS”) software application, such as ArcGIS (Esri; Redlands, Calif.), and assigned to the geographic centroid of the associated US Census block group ID, in which the latitude and longitude of the centroid can be calculated with the default methodology in ArcGIS.

Because of the limited geographical resolution of the EHR data, the results of the Monte Carlo simulation do not provide the desired level of geographical resolution. Thus, in order to generalize the Monte Carlo results, a second, geographic simulation is implemented. The goal of this second simulation is to produce a raster surface describing case location probability that is not tied to a given political geography. Such a surface is amenable to re-aggregation for analysis and mapping using any geographic unit, allowing it to be customized to the unique needs of each desired application or research project.

To accomplish this second simulation at a very fine spatial resolution, the block group averages are first subdivided into associated census blocks, as indicated at step 112, thereby producing subdivided data. As mentioned above, the subdivided data are associated with locations in the geographical region at a third geographical resolution that is finer than the first and second geographical resolutions. As one example, the third geographical resolution can be associated with census blocks. Similarly, geographical regions other than census block groups can be subdivided into smaller geographical regions.

Because census based demographic data is not available below the block group level, subdividing the block group average is performed using total population and total housing units (e.g., population per housing unit), which are available at the census block level. In general, the block group averages can be subdivided by calculating the proportion of each demographic segment in a census block. This proportion is then used as the probability that a patient with a certain demographic profile would reside in that specific census block. In each iteration of the simulation, patients are randomly distributed to census blocks within the zip code based on this probability.

As one specific example, a technique for subdividing the block group averages includes spreading a block group average among associated census blocks by summing block population per housing unit and calculating the percent of that total found in each census block, which defines a proportional weighting. Block specific percentages are then multiplied by the block group average and assigned to the census block. These estimated block averages can then be assigned to the geographic centroid for the associated census block, which again can be implemented using the default methodology in ArcGIS to calculate the longitude and latitude of the centroid.

A krig is then produced from these block estimated averages using either a semivariogram or covariance matrix, as indicated at step 116. As one general example, the krig can be produced using a technique that describes how a given set of observations vary in space. While there are many different techniques for spatial generalization (e.g., spline, inverse distance weighting, pycnophylactic), most techniques estimate the value of a given phenomenon at a given location as a weighted sum of the values found at surrounding locations, or produce no estimate of the error. As such, most of these techniques underestimate the extreme values of any given spatial phenomenon, which is a problem that is typically compensated for by using a dense and uniform data location strategy, or by yielding an estimate of observation quantity without addressing the uncertainty of that estimate.

Because virtually all geographies are spatially biased, that is to say that their areal units are more or less clustered and aligned along a given directional “trend,” the results of the aforementioned simulation should account for spatial biases to make its results more robust. One strategy, kriging, stands apart from the others because it corrects for these spatial biases while also using a variant of a basic linear regression to “fit” a surface to a given spatial distribution. De-clustering eliminates the spatial sampling bias; de-trending, if necessary, eliminates directional biases, and the normal score transformation normally distributes random error. Kriging thus provides a method that utilizes a moderately data driven approach to estimate average values, which can then be used to generate estimates of error. Therefore, in some embodiments, distribution of patient cases resulting from subdividing the block group averages is fit with an appropriate kriging method, which helps correct for spatial bias in the geography and produces a krig that can be used to generate a raster map, or raster surface, as described below.

Although kriging provides the benefits of de-trending, de-clustering, and error estimation, as noted above, it still underestimates both high and low extreme values. In order to compensate for this problem, a second simulation technique is necessary. Preferably, this second simulation should produce normal, or near normal, quantiles. Thus, in a preferred embodiment, a Gaussian Geostatistical Simulation (“GGS”) is performed on the krig to generate a raster map, or raster surface, as indicated at step 118.

In general, the GGS takes the kriged surface estimates and error estimation at the known sample points, performs a normal score transformation, generates a random value against this normal distribution, and transforms that value back into the kriged geographic units. The result is a set of rasters that estimate the average, standard deviation, variance, and quantiles in a regular, continuous raster grid, allowing error estimates to be generated using geographic points rather than aggregated areal units.

The resulting raster map, or raster surface, provides a probabilistic map of patient cases within a zip code. The individual raster cells inside this resultant map are automatically aggregated to the finest resolution possible while still preserving patient privacy. This final map can provide researchers with a more precise depiction of case localization within a geography. In some instances, the method includes displaying the raster map to a user, and may also include displaying or otherwise outputting the error estimates.

In some instances, multiple raster maps can be generated for the same geographical regions, but with associated data obtained at different time points. In this manner, the raster maps can provide translational information about the changes in associated data over time. This type of application can be particularly useful for monitoring the efficacy of a drug or other treatment in a given population.

Referring now to FIG. 2, a block diagram of an example computer system 300 that can implement the methods described above is shown. In some embodiments, the computer system may form a part of a geographic information system (“GIS”), which is generally any information system that integrates, stores, edits, analyzes, shares, and displays geographic information. Software applications implemented in a GIS generally include tools that allow users to create interactive queries (e.g., user-created searches), analyze spatial information, edit data or maps, and present the results of all these operations.

The computer system 300 generally includes an input 302, at least one processor 304, a memory 306, and an output 308. The computer system 300 can also include any suitable device for reading computer-readable storage media. The computer system 300 may be, for example, a workstation, a notebook computer, a tablet device, a mobile device, a multimedia device, a network server, a mainframe, or any other general-purpose or application-specific computing device. The computer system 300 may operate autonomously or semi-autonomously, or may read executable software instructions from the memory 306 or a computer-readable medium (e.g., a hard drive, a CD-ROM, flash memory), or may receive instructions via the input 302 from a user, or any another source logically connected to a computer or device, such as another networked computer or server. In general, the computer system 300 is programmed or otherwise configured to implement the methods and algorithms described above.

The input 302 may take any suitable shape or form, as desired, for operation of the computer system 300, including the ability for selecting, entering, or otherwise specifying parameters consistent with performing tasks, processing data, or operating the computer system 300. In some aspects, the input 302 may be configured to receive data, such as geographical data and associated data. Such data may be processed as described above. In addition, the input 302 may also be configured to receive any other data or information considered useful for generating raster maps or other probabilistic or statistical maps using the methods described above.

Among the processing tasks for operating the computer system 300, the at least one processor 304 may also be configured to receive data, such as geographical data and associated data. In some configurations, the at least one processor 304 may also be configured to carry out any number of post-processing steps on data received by way of the input 302. In addition, the at least one processor 304 may be capable of generating raster maps or other probabilistic or statistical maps as described above.

The memory 306 may contain software 310 and data 312, and may be configured for storage and retrieval of processed information, instructions, and data to be processed by the at least one processor 304. In some aspects, the software 310 may contain instructions directed to generating raster maps or other probabilistic or statistical maps. Also, the data 312 may include any data necessary for operating the computer system 300, and may include any suitable geographical or associated data as described above.

In addition, the output 308 may take any shape or form, as desired, and may be configured for displaying, in addition to other desired information, generated raster maps, other probabilistic or statistical maps, or error estimates associated therewith.

### Example: Incidence of Diabetes and its Association to Socio-Demographic Factors

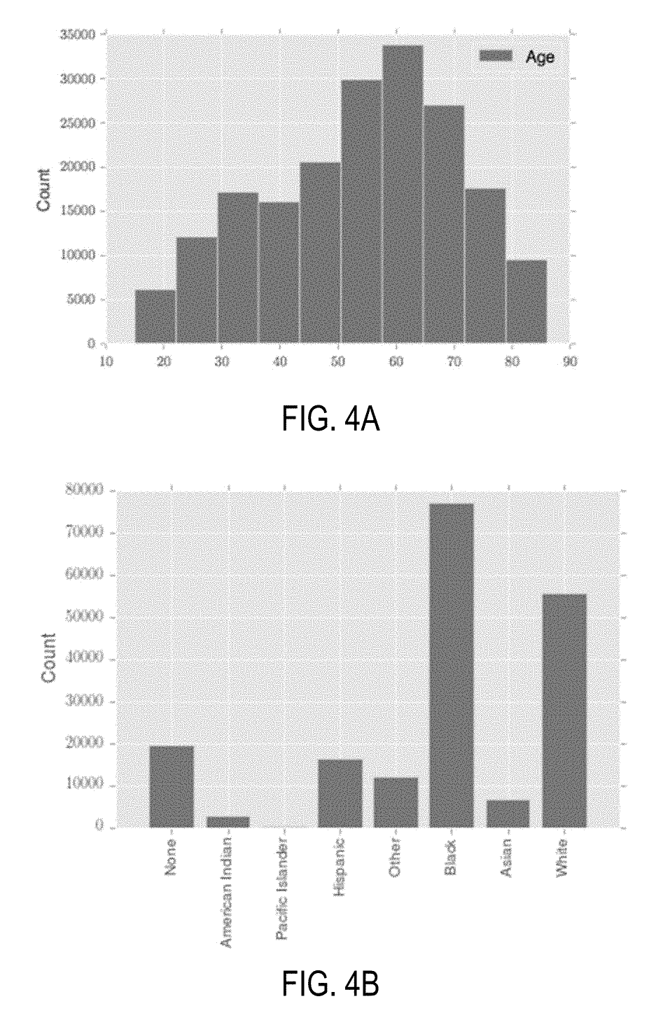

In an example study implementing the methods described above, the incidence of diabetes was analyzed in multiple Chicago zip codes. The input patient data included EHR data from seven healthcare institutions in the Chicago area, accounting for 190,069 total cases (including both Type 1 and Type 2 diabetes) obtained in 2010. The patient data used is described in the study performed by A. Elixhauser, et al., in “Comorbidity Measures for Use with Administrative Data,” Medical Care, 1998; 36(1):8-27. FIGS. 4A and 4B show the age and ethnicity information for the patients' cases. The corresponding census data from 2010 was also provided as an input.

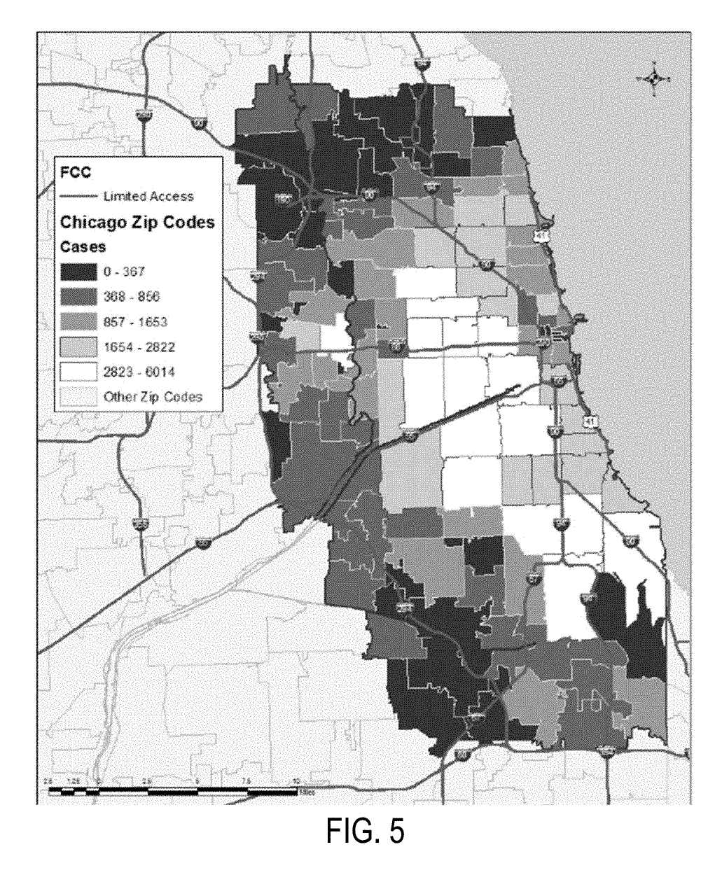

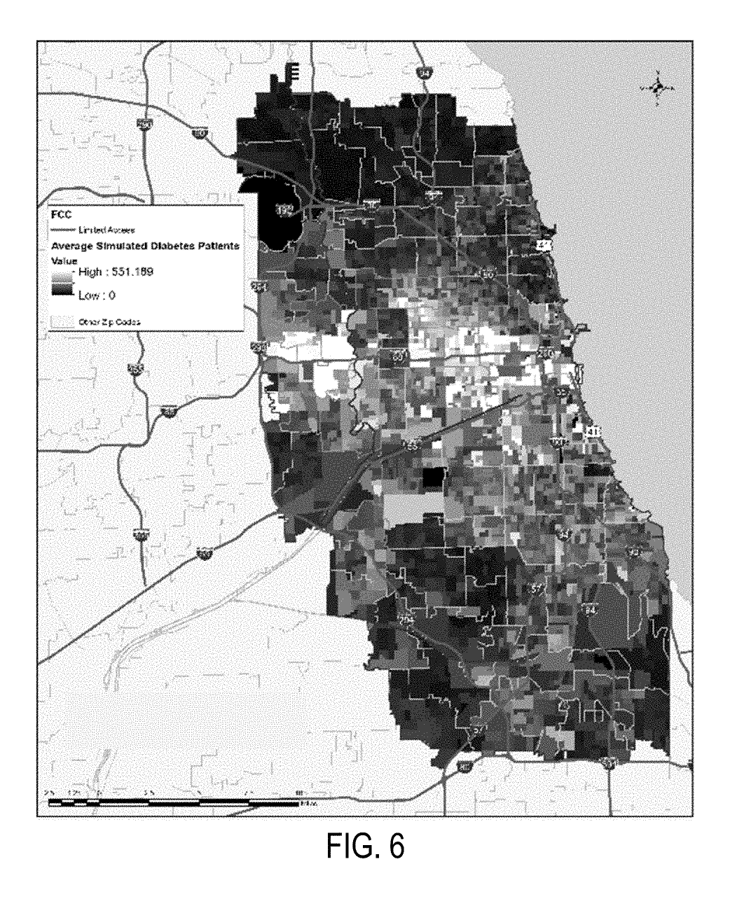

FIG. 5 shows the raw patient record data, which is available only at the zip code level. FIG. 6 shows patient records aggregated by zip code and imputed using a Monte Carlo method based on EHR race, age, and gender information, as described above. Patients were assigned to a block group using the methods described above.

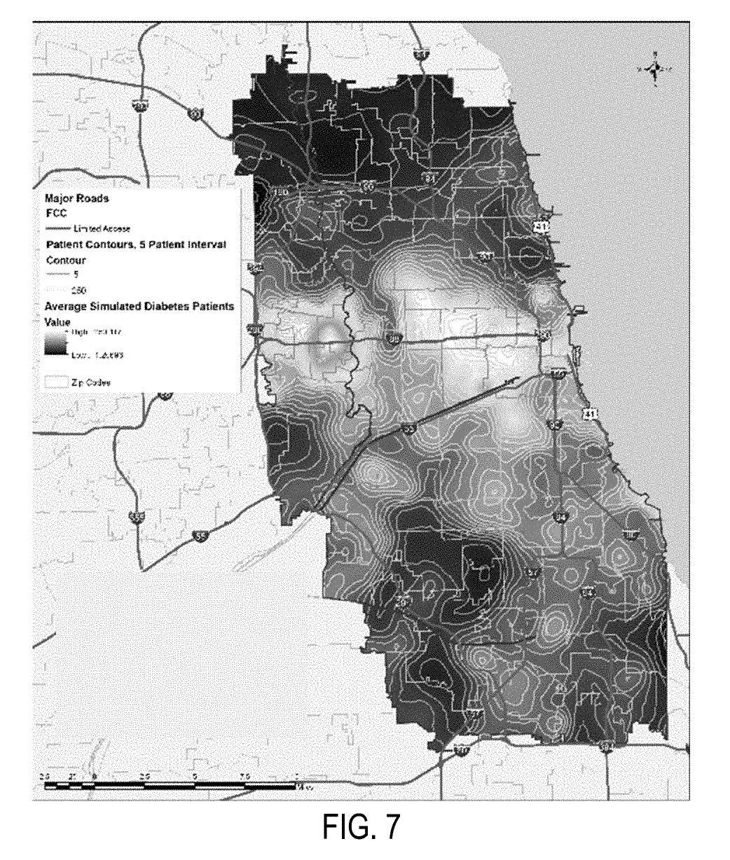

FIG. 7 shows a probabilistic map describing the distribution of patient cases at a geographic resolution finer than the block group and block levels. The map was generated as described above. The average simulated patients by block group were kriged using a simple kriging methods with normally transformed declustered sample points and first ordered removal. In this example, the Hoe Effect semi-variogram provided the best fit. Probable patient locations were interpolated using a GSS methodology with 1,000 realizations.

With this finer resolution, an intra-zip code map that more clearly shows the association of socio-economic status to the prevalence of the disease can be produced. This increased resolution also has a number of other benefits, including a greater correspondence to point-based environmental data (e.g., remote sensing measurements of air quality) and the ability to cluster patient cases in a manner that is not dependent on zip code boundaries. This flexibility can enable researchers to pursue more novel questions about the relationship between environmental factors and patient health once the localization of patient data is no longer a primary restriction in analysis.

### Example: Predicting where Medicaid Patients Reside

In an example study, the method described above were implemented to develop small area estimates for Medicaid patients in two locations, Albuquerque and Chicago.

Using registered Medicaid patients in the study areas, small area estimates of Medicaid patients were developed for both study areas from aggregated zip code patient counts to block groups using the techniques described above.

Chicago Medicaid patients were represented using HealthLNK EHR records. The HealthLNK HER data represented a total of six years (2006-2011) of de-identified & de-duplicated HER data obtained from six different sites across Chicago and thus were only a sample of the total Medicaid patients in the Chicago area. In Chicago, 88,198 Medicaid patients were selected who fell within 217 zip codes in the Cook, DuPage, and Will County areas. These patients represented all patients in those zip codes whose final insurance status in HealthLNK was Medicaid.

Conversely, in Albuquerque, all Medicaid records and patient address data were available. The accuracy assessment in Albuquerque was done over three years (2012, 2013, and 2014), using the most recent address for each Medicaid patient in each year to represent where that patient lived. A total of 283,422 Albuquerque Medicaid patients living within 482 block groups were selected for the study. This included, by year: 190,761 Medicaid patients in 2012; 202,826 Medicaid patients in 2013; and 247,204 Medicaid patients in 2014. The Albuquerque Medicaid patients were address matched using ArcGIS 10.315 and subsequently aggregated by zip code. Because the methodology weights probable patient location using U.S. Census Block Group counts, Albuquerque zip code to block group geographic coincidence could be established in ArcGIS using a spatial join.

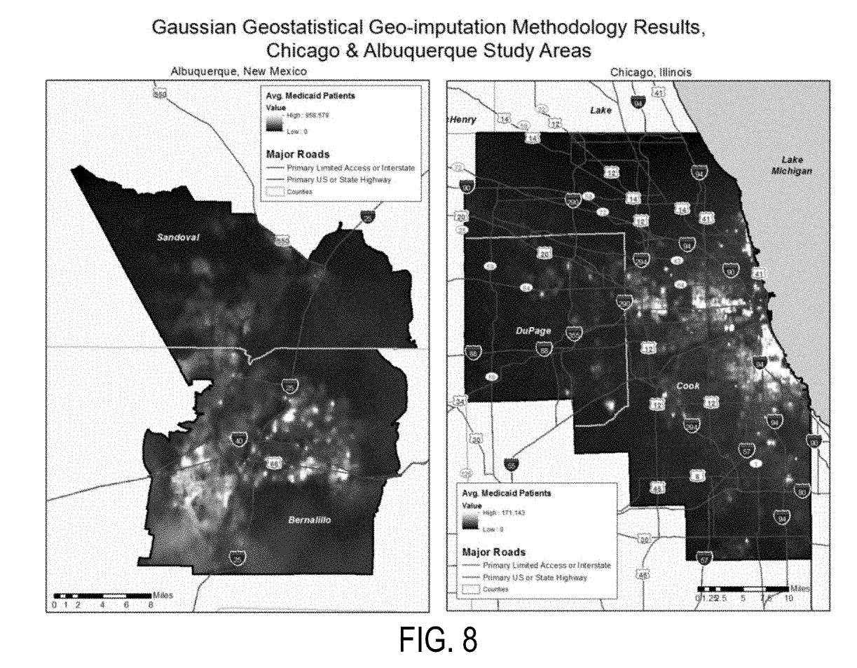

Probable patient block group locations were imputed by performing a Monte Carlo simulation that used limited personal data (e.g., age, gender, and ethnicity) and the associated U.S. Census Block Group totals to establish the probable average number of zip code aggregated Medicaid patients that live within each associated block group. These probable Medicaid patient block group averages were distributed among associated census blocks proportionally and kriged in ArcGIS. As described above, a krig is a raster based statistical surface, similar to a digital elevation model, where the raster cells represent a probability. In this case, the cells represent the probability of the number of Medicaid patients living there. The resulting krig was input to a Gaussian geostatistical simulation to generate an average and standard deviation probability raster to evaluate the accuracy of the predicted average number of Medicaid patients living in each raster cell. Examples of these maps are illustrated in FIG. 8.

In this study, small area estimates of Medicaid patients were thus generated using the same methods applied in two distinct geographies. When visualized on a map, the estimates correlate with known areas of low socioeconomic status (“SES”) in both cities. Compared with a prior validation study applied to voter registration records in North Carolina, the estimates of Medicaid patient distribution generated a larger RMSE. When one considers that, as a rule, population rarely distributes itself “normally” in space, the fact that Medicaid status is dependent on SES and registering to vote is not indicates that it is most likely these socio-economic factors that are responsible for the additional RMSE. Fortunately, the RMSE increase is not that much relative to the total population being simulated and the Error Product for both projects is almost identical.

These facts, taken together, strongly indicate that the krig and subsequent Gaussian geostatistical simulation provide a strong model for Medicaid patient location. Furthermore, the increase in RMSE, most likely due to the clustering effects of low SES, indicates that the block group aggregate average Medicaid patients can serve as a strong dependent variable for future work to apply regression analysis to estimate Medicaid patient population in areas based on socio-economic factors alone.

### Example: Imputing Probability of Disease in Small Areas

In this example study, the methods described above were implemented to generate a probability raster with true standard deviation based on 2014 North Carolina Voter Registry data and corresponding EHR data for that region.

Data Sources—Community Demographics.

For this study, the 2013 American Community Survey (compiled by ESRI) was used as the source of the block group population numbers. The population count for each age, gender, and race grouping was tabulated independently, with five year age bins used.

Data Sources—North Carolina Voter Registry.

Because comprehensive EHR data that includes patient address is difficult to acquire on a wider demographic level without an integrated exchange and several legal agreements, a test of the methods described here was made by using a publicly available dataset that included substantial information for this application and use case. The North Carolina voter registration dataset is a publicly available resource comprised of records for current, registered voters in the state. The records are maintained by the North Carolina State Board of Elections and are updated on a weekly basis and at the time of download consisted of 4.9 million individuals. The individual addresses were geocoded using the ESRI geocoding service.

Given the highly clustered and non-normal nature of settlement patterns, population density, and demographic diversity and their effect on this type of work, a complex study area that included urban, semi-urban, and rural portions was selected.

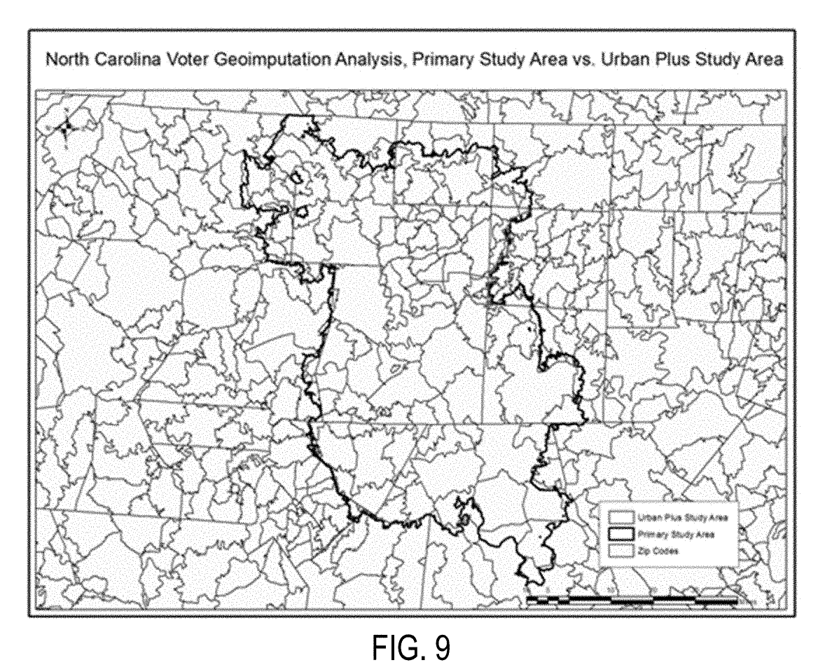

As such, given that the area in and around Winston-Salem was both well covered from a voter standpoint and included urban, semi-urban, and rural components, two separate study areas were chosen in and around this area. The first, the ‘Urban Plus’ area which is depicted with a blue outline in FIG. 9, focused on the potentially most problematic area—urban Winston-Salem generally to include part of its periphery. Urban areas are especially prone to sudden changes in population and demographic density that challenge all attempts to spatially generalize native populations. This first area, the Urban Plus (UP) study area, includes 283 block groups, intersecting 63 zip codes, and including 266,686 voters in and around the area were selected as the test study area. Population densities range from near 55/sq. mile to over 10,000/sq. mile. Because the methodology described here generalizes estimates across the landscape, a subset of only 255 block groups were selected to be tested for accuracy with the remaining 28 included to eliminate error due to the ‘edge effect’.

A second, much larger area outlined in black in FIG. 9, which encompasses the ‘Urban Plus’ area, was also examined. Covering 939 block groups & 249 zip codes, this larger area covers more than 5100 sq. miles, 765,364 total voters, & includes Winston-Salem and the rural/semi-rural areas to the west, north, and south. Block group population densities in these areas range from 15/sq. mile to over 10,000/sq. mile. FIG. 9 is a map showing the relative size and overlap of both study areas.

Voters were aggregated by zip code, to simulate the data as it is stored in most EHR systems. Subsequently, the study area block group centroids were also aggregated by zip code using a spatial join, thus establishing the spatial contiguity between the two geographies. The joined and tabulated census/zip code association data was transferred to a table for testing.

Geographic Record Disaggregation Methodology.

A Monte Carlo simulation was performed to randomly distribute the patient cases within a zip code. In each simulation a patient with age “a,” race “r,” and gender “g” is probabilistically assigned to a block group. The probability for each block group is calculated as shown in Eqn. (1) above. If a patient was missing any demographic field then the population used was based on the remaining, known demographic attributes, as described above.

Each patient case was assigned to a block group and the number of cases in each block group was summed in the output. This process was repeated to produce 1,000 independent realizations of the distribution of patient cases. The number of patient cases in each block group was averaged from these realizations and then imported into the ArcGIS software. Each block group average was then assigned to the geographic centroid for the US Census block group ID, with the latitude and longitude of the centroid calculated with the default methodology in ArcGIS.

In order to generalize the Monte Carlo results out from the block group centroids, a second, geographically explicit simulation was used. The goal of this second simulation is to produce a raster surface describing case location probability that is not tied to a given political geography. Such a surface would be amenable to re-aggregation for analysis and mapping using any geographic unit, allowing it to be customized to the unique needs of each research project.

To accomplish this, a technique describing how a given set of observations vary in space was implemented. Because many geographies are spatially biased, that is to say that their areal units are more or less clustered and aligned along a given directional “trend” that reflects local physiography, the results of the simulation should account for these biases if they are to be verified. As described above, kriging can be used because it corrects for these errors while also using a variant of basic linear regression to fit a surface to a given spatial distribution. The result is a method that utilizes a moderately data driven approach to estimate average values which can then be used to generate estimates of error.

While kriging provides the benefits of de-trending, de-clustering, and error estimation, as noted above, it can still underestimate both high and low extreme values, which may skew results that do not compensate for it. A simulation based on the results of the initial krig can therefore be implemented. As described above, a Gaussian Geo-statistical Simulation (“GGS”) can be utilized. GGS takes the kriged surface estimates and error estimation at the known sample points, performs a normal score transformation, generates a random value against this normal distribution, and transforms that value back into the kriged geographic units. The result is a set of rasters that estimate the average, standard deviation, variance, and quantiles in a regular, continuous raster grid, allowing error estimates to be generated using geographic points rather than aggregated areal units.

Because census data only records identifying demographic and age data at the block group level and above, Monte Carlo averages cannot be developed for geographic levels finer than the block group. However, for the GGS to develop accurate predictions of citizen location, estimated averages should be made at a finer resolution than the block group. As such, the number of housing units per block, which represent real estimates of citizen location, can be used to further refine the demographic and age based estimates calculated by the Monte Carlo for the block groups.

These housing density refined Monte Carlo averages were assigned to the centroid for a given census block and subsequently fitted as the response variable in a simple kriged surface. A first or second order transformation was applied to the census block centroid layer as needed. In the case of the “Urban Plus” study area, a second order transformation was used. As noted above, to adjust for the non-normality inherent in geographic data, a de-trending and de-clustering routine can be applied to the block centroids as well. Finally, a de-trending kernel was selected to accomplish these tasks, the selection of which was specific to the given geography. For the North Carolina voter data used in this study, an exponential transformation was used.

Once the krig and the associated output point layer containing the predicted, real, and error terms for each of the block centroid points used in developing the krig were completed, they were inputted to the GSS process. The krig surface was conditioned by the krig output point layer and the standard deviation from the initial krig was used as estimate of the error. Because the housing density modified demographic averages were used as the response variable in creating the krig, those same estimated averages were used as the “true” values for the GGS. Two separate raster cell resolutions were tested: 0.01 mi² in the “Urban Plus” study area and 0.1 mi² in the total study area.

The process described above was conducted multiple times using samples of the total voter population. No tests were performed on the entire voter population in study areas. As such, each test represents a real test of an imputed sample's ability to predict itself. Samples were run at 10 sample levels: 1, 2, 5, 10, 15, 20, 25, 30, 40, and 50 percent of the total voter population. In this way, a sample total accuracy response estimate could be developed and compared to future samples with a known “n.” Accuracy was tested using voter address and involved comparing the sample total number of voters per raster cell to the predicted average and standard deviation for that same cell.

Results and Discussion.

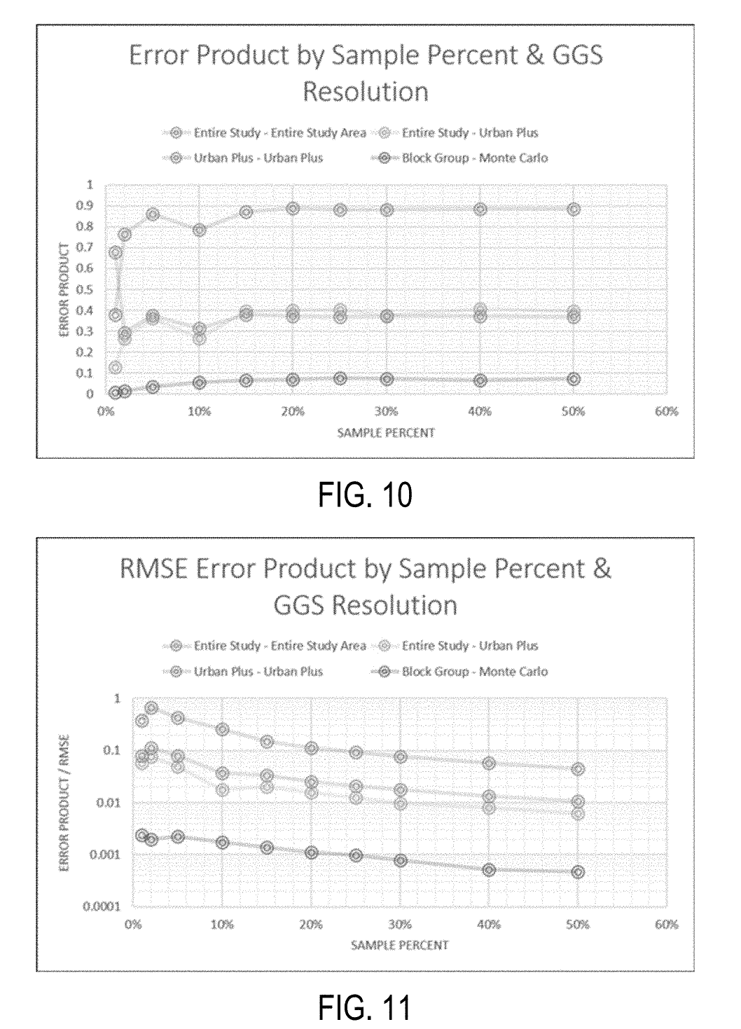

FIG. 10 outlines the Error Product for each of the output formats by simulation type, study extent, & raster resolution. The Error Product at low resolution (PS) does not change when moving from the entire study area extent to just the Urban Plus (UP) extent. As one would expect, this indicates that much of the method's accuracy is tied to the spatial resolution of the output raster.

Given that 0.01 mi² represents a raster cell that is 0.1 mi on each side, 0.01 mi² is approximately (slightly larger) a city block. Typically, in an American city there are 12 city blocks per mile. As such, the UP GGS resolution is effectively the same size as the base unit for residential structure in most cities. By contrast, at 0.1 mi², the PS resolution is approximately 0.31 mi on a side, or 3 city blocks. Mathematically, that would make it more of an average allowing it to mask important variations in residential density that would show up as a decrease in the Error Product. Thus, the results presented here demonstrate that an effective method for interpolating population distribution is preferable and that the resolution of the output should be selected to conform to human settlement pattern structure.

Based on a logarithmic scale, FIG. 11 shows how the BG-Monte Carlo simulation is almost an order magnitude worse than its GGS counterparts. As expected, the RMSE Error Product for the UP-Urban Plus study area, which has the finest spatial resolution, is by far the best performer.

To further evaluate the combined montecarlo/GGS methodology, the results presented here were compared across interpolation types. Pycnophylactic interpolation, a commonly used method of population interpolation which is unique in that the total population count by aggregated unit is not allowed to change from the value it is provided, was chosen for comparison purposes. It is, generally, the preferred interpolation scheme for dasymetric mapping schemes due to its ‘mass preserving’ nature.

While there are many other interpolation methodologies available, including Inverse Distance Weighting (IDW), co-kriging, and spline, aside from IDW, these methods are all similar to the krig used as a base for the GGS. As such, it was presumed that these methods would present results that were not much different than the krig that serves as a base for the GGS and thus were not considered. Of these additional interpolation methods, only pycnophylactic was demonstrably different.

GGS provides a benefit over these methods in that it calculates an accurate estimate of the error at each interpolated raster cell rather than only at ‘known’ sample points. The usefulness of this additional data, aside from enabling the generation of statistics such as the Error Product, is specific to the field of study being modelled. However, as mentioned earlier, knowing the error at any given point within a study area can provide useful data for generating process based signatures that cross academic disciplines or different applications. In the case of the EHRs, evaluating data ‘clusters’, may lead to an effective tool for environment/disease interactions.

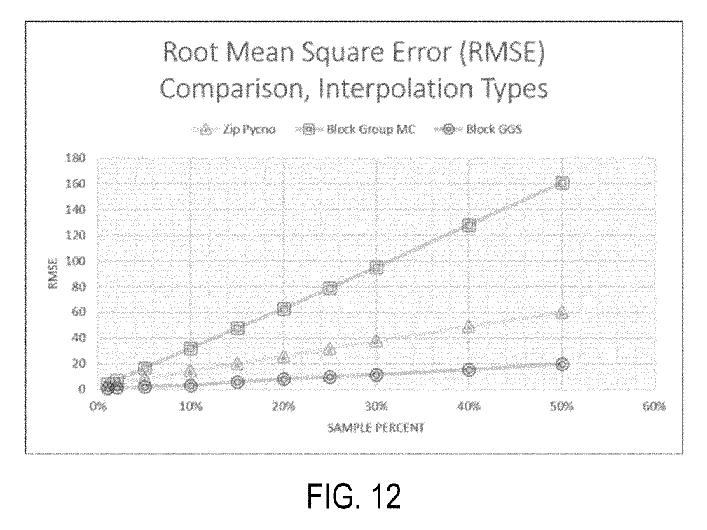

In FIG. 12, RMSE was used to illustrate the relative accuracy of each interpolation method. As pointed out above, with no estimate of the error in Pycnophylactic interpolation, relative comparison of the error products for each is impossible. Thus, in terms of its usefulness outside of simply redistributing aggregated population, Pycnophylactic falls short of both the Monte Carlo method alone and the GGS.

The present disclosure has described one or more preferred embodiments, and it should be appreciated that many equivalents, alternatives, variations, and modifications, aside from those expressly stated, are possible and within the scope of the invention.

1. A computer-implemented method for generating a raster map that depicts probabilistic information related to data associated with locations within a geographical region, the steps of the method comprising:
(a) providing to a computer system, associated data that comprises information associated with first locations associated with at least one geographical region at a first geographical resolution;
(b) providing to the computer system, geographical data that defines second locations associated with the at least one geographical region at a second geographical resolution that is finer than the first geographical resolution;
(c) distributing, with the computer system, the associated data across the second locations, wherein the associated data are distributed at the second geographical resolution;
(d) generating averaged data at each of the second locations by averaging, with the computer system, the associated data distributed to each of the second locations;
(e) generating subdivided data by subdividing, with the computer system, the averaged data at the second locations onto third locations associated with the at least one geographical region, wherein the third locations define a third geographical resolution that is finer than the second geographical resolution;
(f) producing kriged data with the computer system by processing the subdivided data at the third locations using a kriging process;
(g) producing a raster map by performing with the computer system, a Gaussian geostatistical simulation on the kriged data, the raster map having pixels that depict a probability of the associated data being spatially correlated with the third locations.

2. The method as recited in claim 1, wherein the geographic data comprises census data that associates demographic information with the at least one geographic region.

3. The method as recited in claim 2, wherein the second geographical resolution corresponds to census block groups and the third geographical resolution corresponds to at least one of census blocks or areal units smaller than census blocks.

4. The method as recited in claim 1, wherein the associated data comprises electronic health record data associated with the at least one geographical regions.

5. The method as recited in claim 4, wherein the first geographical resolution correspond to a postal code.

6. The method as recited in claim 1, wherein step (c) includes performing a Monte Carlo simulation to randomly distribute the associated data across the second locations.

7. The method as recited in claim 6, wherein step (c) includes repeating the Monte Carlo simulation a plurality of time to produce a plurality of independent realizations of distributions of the associated data.

8. The method as recited in claim 7, wherein step (d) includes producing summed associated data at each second location by summing the associated data distributed to each second location for each of the plurality of independent realizations, and averaging the summed associated data at each second location across the plurality of independent realizations.

9. The method as recited in claim 1, wherein step (e) includes subdividing the averaged data based on a proportional weighting determined in part based on information associated with the third locations.

10. The method as recited in claim 9, wherein the third geographical resolution corresponds to census blocks, and the proportional weighting is determined based on a population per housing unit in each census block.

11. The method as recited in claim 1, wherein the kriging process performed in step (f) includes performing at least one of de-clustering, de-trending, or error estimation on the subdivided data.

12. The method as recited in claim 11, wherein the kriging process uses at least one of a semivariogram or a covariance matrix.

13. The method as recited in claim 1, wherein the raster map produced in step (g) contains information associated with at least one of averages, standard deviations, variances, and quantiles in a regular and continuous raster grid.

14. The method as associated with claim 13, wherein step (g) further comprises producing error estimates based on the raster map, wherein the error estimates are produced using geographic points associated with the third locations.
